(19) United States
(12) Patent Application Publication
(10) Pub. No.: US 2004/0178691 A1
(43) Pub. Date: Sep. 16, 2004

(54) Stator and rotary electric machine with the stator

(75) Inventors: Kazuaki Sanada, Imizu (JP); Takashi Matsunobu, Hitachinaka (JP); Shigeo Amagi, Naka (JP); Mamoru Kimura, Hitachi (JP)

Correspondence Address: McDermott, Will & Emery, 600 13th Street, N.W., Washington, DC, 20005-3096, US

(73) Assignee: HITACHI, LTD.

(21) Appl. No.: 10/641,113

(22) Filed: Aug. 15, 2003

(30) Foreign Application Priority Data
Mar. 14, 2003 (JP) 2003-069075

(51) Int. Cl. H02K 1/00

(52) U.S. Cl. 310/181

(57) ABSTRACT

To reduce the stator size and realize a compact, high-efficiency and high-output rotary electric machine.

(Means for Solving the Problems)

There is provides a stator comprising a stator core equipped with multiple slots and coils built in the slots of the stator core; multiple coils being laid in each slot and bent inward and outward in the radial direction of the stator. With this construction, it becomes possible to best utilize each space on the outside and inside in the radial direction of the stator and shorten the length of the coil end in the axial direction of the rotary electric machine and in the radial direction of the stator without laying the coils complicatedly on the stator end.

### BACKGROUND OF THE INVENTION

1. Field of the Invention

The present invention relates to a rotary electric machine, particularly to a stator used for a rotary electric machine.

2. Prior Art

A stator used for a rotary electric machine such as generator comprises a stator core equipped with multiple slots and coils wound through these slots. Herein, a unit of coil is a bundle of multiple conductors.

A portion of coil that is wound from the end of one slot to the end of another is called the coil end and serves to connect the coils laid in each slot.

If the size of the coil end becomes bigger, however, 1) the size of the stator becomes bigger, 2) the electric resistance of the coil increases, resulting in decrease of output and generation of heat, and 3) the circulation of cooling air is blocked, resulting in decrease of cooling efficiency. For these reasons, in order to realize a compact, high-efficiency and high-output generator or the like, it is necessary to shorten the coil length at the coil end so as to avoid the interference between coils and to shorten the lengths of the coil end in the axial direction of the rotary machine and in the radial direction of the stator so as to reduce the stator size.

There have been disclosed techniques for reducing the stator size: 1) a technique where coils laid on the inner side in the slot are bent near the core surface and those laid on the outer side in the slot are bent off the core surface (see Patent Document 1, for example), and 2) a technique where coils are twisted together outside the slot and overlapped on adjacent coils (see Patent Document 2, for example).

[Patent Document 1]

Japanese Application Patent Laid-Open Publication No. Hei 09-215238 (page 5, FIG. 1)

[Patent Document 2]

Japanese Application Patent Laid-Open Publication No. 2002-44890 (page 10, FIG. 2)

### SUMMARY OF THE INVENTION

(Problems to be Solved by the Invention)

With the technique disclosed in the above Patent Document 1 (Japanese Application Patent Laid-Open Publication No. Hei 09-215238), however, since coils are bent in the same direction, there remains a problem that the coil end cannot be made lower in height.

With the technique disclosed in the above Patent Document 2 (Japanese Application Patent Laid-Open Publication No. 2002-44890), however, since coils are twisted together, there remains a problem that the technique may not apply if the rigidity of the coil is high.

It is, therefore, an object of the present invention to reduce the size of stator and realize a compact, high-efficiency and high-output rotary machine so as to solve the above problems.

(Means for Solving the Problems)

To achieve the above object, according to the present invention, there is provided a stator, comprising a stator core equipped with multiple slots and coils built in the slots of the stator core; multiple coils being laid in each slot and bent inward and outward in the radial direction of the stator.

### BRIEF DESCRIPTION OF THE DRAWINGS

FIG. 1

Brief view of the rotary electric machine according to the embodiment 1

FIG. 2

Explanatory figure of the coil end of the rotary electric machine according to the embodiment 1

FIG. 3

View of the rotary electric machine according to the embodiment 1, viewing from the longer shaft side

FIG. 4

Explanatory figure of the coil end of the rotary electric machine according to the comparative example 1

FIG. 5

Explanatory figure of the coil end of the rotary electric machine according to the embodiment 1

FIG. 6

Explanatory figure of the coil end of the rotary electric machine according to the comparative example 2

FIG. 7

Explanatory figure of the coil end of the rotary electric machine according to the comparative example 3

FIG. 8

Brief view of the generator according to the embodiment 2

FIG. 9

(a) Brief view of the generator according to the embodiment 3

(b) Explanatory view of the coil end of the rotary machine according to embodiment 3

### DESCRIPTION OF THE PREFERRED EMBODIMENTS

Preferred embodiments of the present invention are described hereunder.

The first form of the invention is a stator comprising a stator core equipped with multiple slots and coils built in the slots of the stator core; multiple coils being laid in each slot and bent inward and outward in the radial direction of the stator. The second form is a stator according to the first form, wherein the coils bent inward in the radial direction of the stator are made equal in number to those bent outward. In addition, the third form is a stator according to the second form, wherein the coils bent inward and outward in the radial direction of the stator are three-phase concentric coil. The fourth form is a stator according to the third form, wherein the coils bent inward and outward in the radial direction of the stator are built into a layer structure of two rows by three layers. With this construction, it becomes possible to best utilize each space on the outside and inside in the radial direction of the stator and shorten the length of the coil end in the axial direction of the rotary electric machine and in the radial direction of the stator without laying the coils complicatedly on the stator end. Besides, the fifth form of the invention is a stator according to the first form, wherein an insulation plate, which is provided with a hole corresponding to the slot, is put on the end of the stator core. With this construction, coils can always be bent at the minimum radius of curvature, because of which the forming efficiency and bending accuracy of the coils improve and the length of the coil end in the axial direction of the rotary machine can be shortened. In addition, since the coils no longer contact any sharp edge around the slot in bending process, damage to the insulation coating on the coils can be prevented. If the distance between the coil at the coil end and the stator core is too close, leak current increases and so the generator efficiency decreases. By using an insulation plate 15, however, because a certain distance can be maintained between the coil 13 at the coil end and the stator core 5, the leak current can be minimized and the efficiency can be improved. The sixth form is a stator according to the fifth form, wherein the edge of the hole is rounded. By rounding the edge of the hole, damage to the insulation coating on the coils can be prevented more efficiently. The seventh form is a stator according to the first form, wherein the multiple coils laid in each slot of the sixth form are wound through other similar slots.

The eighth form of the invention is a rotary machine comprising a housing, bearings fixed in the housing, a rotary shaft supported by the bearings, a rotor fixed on the rotary shaft, and a stator so fixed in the housing as to be positioned around the rotor; the stator comprising a stator core equipped with multiple slots and coils built in the slots of the stator core; multiple coils being laid in each slot and bent inward and outward in the radial direction of the stator. The ninth form is a rotary electric machine according to the eighth form, wherein the coils bent inward in the radial direction of the stator are made equal in number to those bent outward. Besides, the tenth form is a rotary electric machine according to the ninth form, wherein the coils bent inward and outward in the radial direction of the stator are three-phase concentric coil. The eleventh form is a rotary machine according to the tenth form, wherein the coils bent inward and outward in the radial direction of the stator are built into a layer structure of two rows by three layers. With this construction, it becomes possible to best utilize each space on the outside and inside in the radial direction of the stator, shorten the length of the coil end in the axial direction of the rotary electric machine and in the radial direction of the stator without laying the coils complicatedly on the stator end, and realize a compact, high-efficiency and high-output rotary machine.

Besides, the twelfth form of the invention is a rotary electric machine according to the eighth form, wherein an insulation plate, which is provided with a hole corresponding to the slot, is put on the end of the stator core. The thirteenth form is a rotary electric machine according to the twelfth form, wherein the edge of the hole is rounded.

Further, the fourteenth form of the invention is a rotary electric machine according to the eighth form, wherein a permanent magnet is embedded in the rotor and fastened with a magnet cover.

And the fifteenth form of the invention is a stator comprising a stator core equipped with multiple slots and coils built in the slots of the stator core; multiple coils being laid in each slot and bent inward and outward in the radial direction of the stator; and the multiple coils laid in each slot being wound through other similar slots. With this construction, it becomes possible to best utilize the space on the end of the stator core (stator end) and shorten the length of the coil end in the axial direction of the rotary machine and in the radial direction of the stator without laying the coils complicatedly on the stator end.

A detailed description of the preferred embodiments of the invention is provided hereunder with reference to the accompanying drawing figures.

(Embodiment 1)

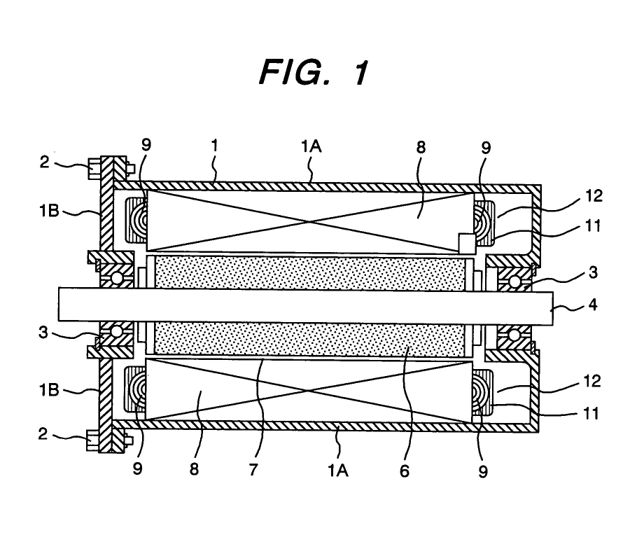

FIG. 1 is a cross-sectional view of the rotary electric machine according to the embodiment 1 of the invention. The rotary electric machine mainly comprises a housing 1 which is made from a cylindrical housing part 1A and an approximately disc-shaped housing part 1B, connected with each other with bolts 2; bearings 3 which is fastened on the housing 1 and supports a rotary shaft 4; rotor 6 fastened on the rotary shaft 4; and stator 8 which is positioned around the rotor 6 and fastened inside the housing 8, leaving a clearance 7. The rotary shaft 4 is then connected to the output shaft of an engine by means of a belt pulley mounted on the end of the shaft or forms part of the rotary shaft of a turbine. The stator 8 is made into a cylindrical shape with layers of ring-shaped thin magnetic steel plates, and multiple slots, which are grooves for laying coils 9 inside, are provided in it. The coil 9 is made of a bundle of copper wires with insulation coating and laid through the slot to be wound around the stator 8. In winding the coil 9, the coil 9 is bent outside the slot near the end of the stator 8 and wound through another slot. Heat-cured resin 11 is applied to the bent portion of the coil 9 so as to coat the coil 9. In this specification, the bent portion of the coil is hereinafter called the coil-end portion coil and the coil-end portion coil together with the resin 11 that coats the coil-end portion coil is called the coil end 12. Besides, in FIG. 1, cooling air from a cooling air inlet port, not shown, installed on the housing 1, circulates through the space between the coil end 12 and housing and the clearance 7 between the rotor 6 and stator 8 so as to cool down the coil end 12 and rotor 6.

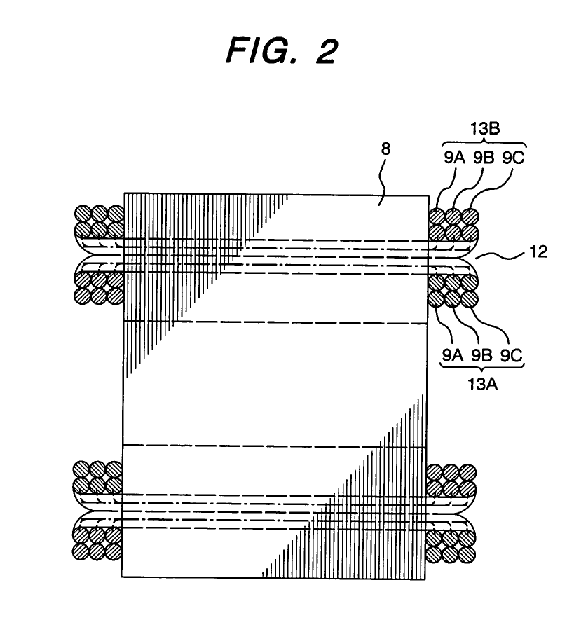

FIG. 2 is a cross-sectional view of the stator 8 according to this embodiment. FIG. 2 shows a three-phase concentric-coil stator. In FIG. 2, for the convenience of explanation, resin is not shown but the coil-end portion coil not covered with resin is shown.

Multiple coils 9 are built in each slot and each of the coils 9 is wound through a slot into another. In winding a coil, the coil is bent and the coil-end portion coil 13 is formed. The coil-end portion coil 13 comprises the coil-end portion coil 13A that are bent inward in the radial direction of the stator and the coil-end portion coil 13B that are bent outward in the radial direction of the stator. Each coil-end portion coil has a three-layer structure, comprising U-phase coil 9A, W-phase coil 9B and V-phase coil 9C. Any coil adjacent to the U-phase coil 9A, W-phase coil 9B and V-phase coil 9C in the radial direction of the stator is of the same-phase coil, respectively. In this specification, the construction of a coil where a bundle of three-phase wires is wound as explained above is called a three-phase concentric coil.

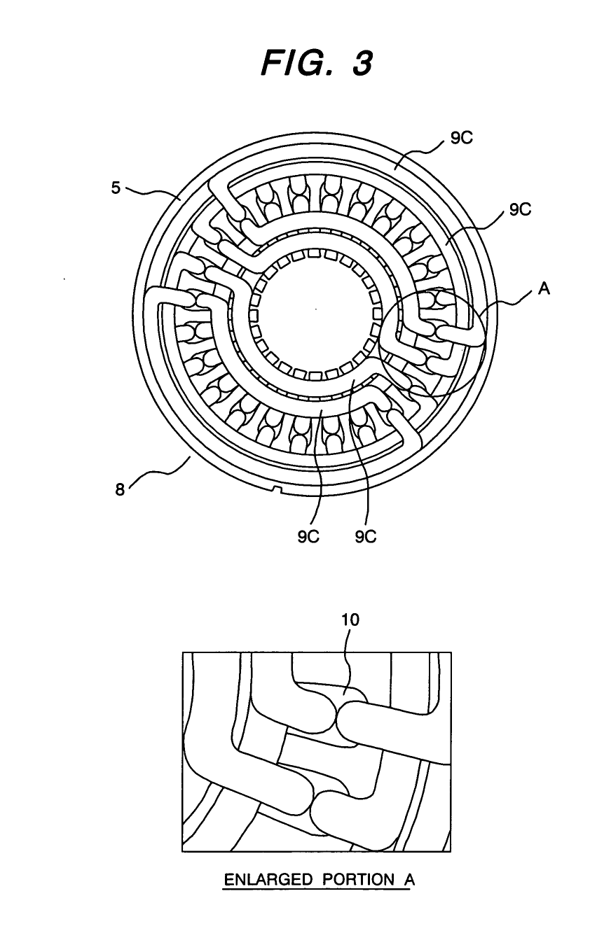

FIG. 3 shows the coil end of the stator 8 of this embodiment. FIG. 3 is a view from the longer shaft side of the rotary shaft and shows how the coils are bent and wound through the slots.

The stator 8 comprises a stator core 5 equipped with multiple slots 10 and multiple coils 9 laid in the slots 10 of the stator core 5. In FIG. 3, twenty-four slots 10 are provided in the circumferential direction.

Coils 9 led out of the slot 10 are bent and distributed evenly inward and outward in the radial direction of the stator from the led-out position of the coils 9.

By bending and distributing the coils evenly inward and outward in the radial direction of the stator, it becomes possible to best utilize each space on the outside and inside in the radial direction and shorten the length of the coil end in the axial direction of the rotary machine and in the radial direction of the stator without laying the coils complicatedly on the stator end. While, in this embodiment, the multiple coils laid in each slot are bent and distributed evenly inward and outward in the radial direction of the stator, it is allowable to bend and distribute the coils in a none-radial direction so far as the above effect is attained by bending and distributing the coils evenly. Bending and distributing the coils in the radial direction, however, enables to attain a more symmetric layout as shown in FIG. 3 and so coil designing becomes easier.

With the stator of the present invention, as explained above, the stator becomes smaller in size and a compact, high-efficiency and high-output rotary electric machine can be realized.

### COMPARATIVE EXAMPLE 1

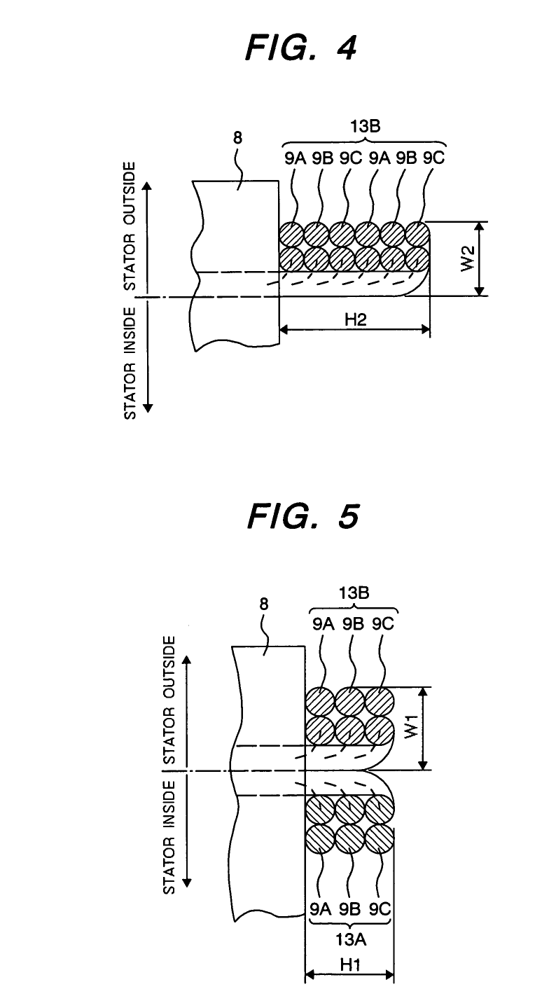

FIG. 4 is a cross-sectional view of part of the coil end portion of a rotary electric machine according to a comparative example 1. Other portions than the coil end portion are nearly equal to those of the embodiment 1. On the coil end shown in FIG. 4, resin coating is omitted for the convenience of explanation.

In FIG. 4, the coil-end portion coils 13B led out of each slot are all bent outward in the radial direction of the stator, forming a total six-layer structure, comprising two rows of U-phase coils 9A, two rows of W-phase coils 9B and two rows of V-phase coils 9C, and further two rows of U-phase coils 9A, two rows of W-phase coils 9B and two rows of V-phase coils 9C. Any coil adjacent to the U-phase coil 9A, W-phase coil 9B and V-phase coil 9C in the radial direction of the stator is of the same-phase coil, respectively.

Given that the length of the coil-end portion coil from the stator end to the upper surface in the axial direction of the rotary electric machine is H2 and the width of the coil-end portion coil 13B from the center of the led-out position to the side surface is W2 in this example, and that the length of the coil-end portion coil from the stator end to the upper surface in the axial direction of the rotary machine is H1 and the width of the coil-end portion coil 13B from the center of the led-out position to the side surface is W1 in the embodiment 1 (see FIG. 5), comparison is made to each other. The result is that W2 is nearly equal to W1 but that H2 is two times as long as H1. This difference is particularly remarkable where coils led out from multiple slots are overlapped. Besides, since the coils are bent toward only one side in the radial direction (toward the stator outside-diameter side in FIG. 4), no coil is laid on the stator inside-diameter side and so the space there cannot be best utilized. That is to say, because the length of the coil end in the axial direction of the rotary electric machine in the comparative example 1 becomes longer than that in the embodiment 1 and also because the space around the led-out position of the coils cannot be best utilized, the stator becomes larger in size.

As explained above, the rotary electric machine in the comparative example 1 disturbs smooth circulation of the cooling air as compared to that in the embodiment 1.

### COMPARATIVE EXAMPLE 2

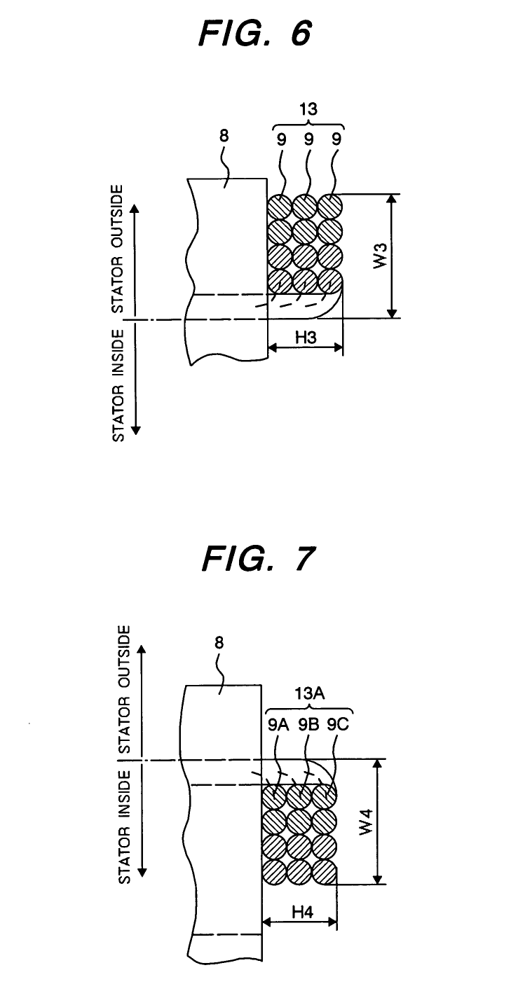

FIG. 6 is a cross-sectional view of part of the coil end portion of a rotary electric machine according to a comparative example 2. Other portions than the coil end portion are nearly equal to those of the embodiment 1. On the coil end shown in FIG. 6, resin coating is omitted for the convenience of explanation.

In FIG. 6, the coil-end portion coils 13B led out of each slot are all bent outward in the radial direction of the stator (toward the stator outside-diameter side), forming a total three-layer structure, comprising four rows of U-phase coils 9A, four rows of W-phase coils 9B and four rows of V-phase coils 9C. Any coil adjacent to the U-phase coil 9A, W-phase coil 9B and V-phase coil 9C in the radial direction of the stator is of the same-phase coil, respectively.

Given that the length of the coil-end portion coil from the stator end to the upper surface in the axial direction of the rotary electric machine is H3 and the width of the coil-end portion coil 13B from the center of the led-out position to the side surface is W3, comparison is made to H1 and W1 in the embodiment 1 (see FIG. 5) as in the comparative example 1. The result is that H3 is nearly equal to H1 but that the coil end width W3 is two times as wide as W1. That is to say, since the coil width needs to be double in the comparative example 2, more space per slot is needed on the stator outside-diameter side. As a result, because the length of the coil end in the axial direction of the rotary electric machine in the comparative example 2 becomes longer than that in the embodiment 1, the stator becomes larger in size.

As explained above, with the rotary electric machine according to the comparative example 2, the stator becomes larger in size and consequently smooth circulation of the cooling air is disturbed.

### COMPARATIVE EXAMPLE 3

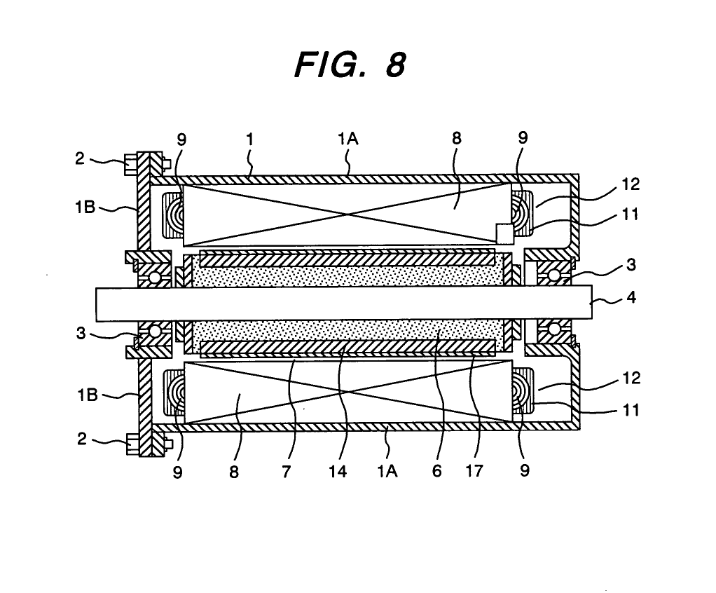

FIG. 7 is a cross-sectional view of part of the coil end portion of a rotary electric machine according to a comparative example 3. Except for the coil-end portion coils that are all bent inward in the radial direction of the stator (toward the stator inside-diameter side), other portions are nearly equal to those of the comparative example 2. On the coil end shown in FIG. 7, resin coating is omitted for the convenience of explanation.

Given that the length of the coil-end portion coil from the stator end to the upper surface in the axial direction of the rotary electric machine is H4 and the width of the coil-end portion coil 13B from the center of the led-out position to the side surface is W4, comparison is made to H1 and W1 in the embodiment 1 (see FIG. 5) as in the comparative example 2. The result is that H4 is nearly equal to H1 but that the coil end width W4 is two times as wide as W1. That is to say, more space is needed (approximately double the area) on the stator inside-diameter side in the comparative example 3 than in the embodiment 1 and, as a result, the length in the axial direction of the stator of the rotary electric machine becomes longer and the stator becomes larger in size. The above excess of length and size is more remarkable than in the comparative example 2 because the coils are bent inward in the radial direction of the stator.

As explained above, with the rotary electric machine according to the comparative example 3, the stator becomes larger in size and consequently smooth circulation of the cooling air is disturbed.

(Embodiment 2)

FIG. 8 is a cross-sectional view of a high-speed generator for a micro gas turbine according to the embodiment 2. On the generator of the embodiment 2, a permanent magnet 14 is embedded in the rotor 6 of the embodiment 1 and fastened with a magnet cover 17. Other portions are nearly equal to those of the embodiment 1.

In the case of micro gas turbine, a turbine generator, an integrated combination of turbine and generator, is operated at a very high speed like tens of thousands rotations per minute and power is generated at a high-frequency as high as several kHz, thereby realizing compact size and high output. The rotor 6 of this generator employs rare-earth permanent magnet, of which technology has made remarkable progresses these years in view of realizing higher output and higher efficiency. Because the magnetic characteristic of rare-earth permanent magnet deteriorates and so the generation efficiency lowers as it becomes hot, it is necessary to efficiently release heat from the coil 9 of the stator that serves as a heat source. For this purpose, cooling air from a cooling air inlet port, not shown in FIG. 8, installed on the housing 1, circulates through the space between the coil end 12 and housing and the clearance 7 between the rotor 6 and stator 8 so as to cool down the coil end 12 and rotor 6.

With the coil end design shown in this embodiment, as explained above, the height of the coil end can be low and the size be small. Since the temperature increase of the rotor utilizing a permanent magnet is prevented as above, higher-output and higher-efficiency rotary machine can be realized.

(Embodiment 3)

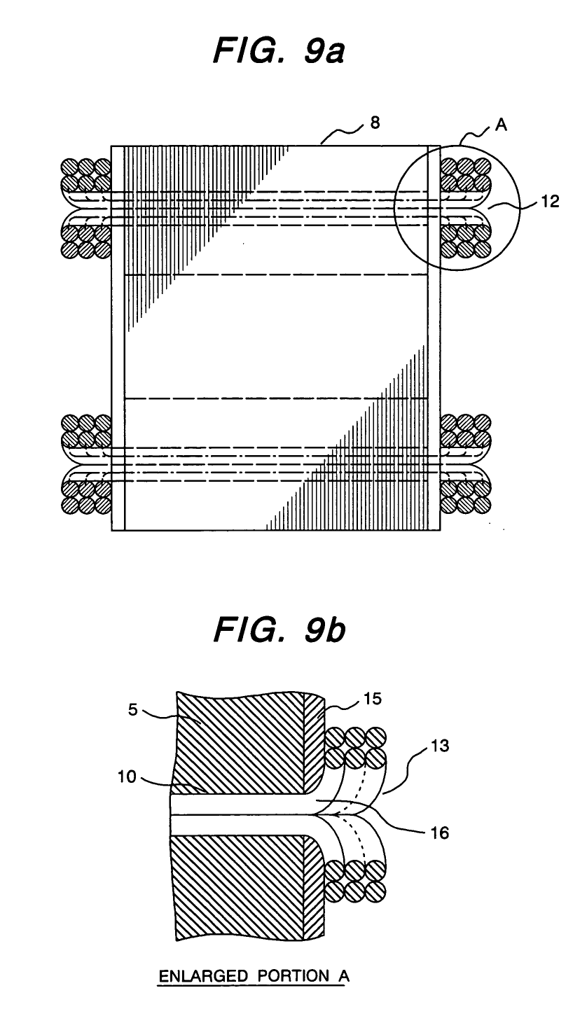

FIG. 9(a) shows a stator according to the embodiment 3. An insulation plate is put on the end of the stator of the embodiment 3. Other portions are nearly equal to those of the embodiment 1. FIG. 9(b) is an enlarged view of part of the coil end in FIG. 9(a).

A hole 16 corresponding to the slot 10 of the stator core 5 is provided on the insulation plate 15 of the embodiment 3, the size of the hole 16 being equal to the size of the slot. Edge around the hole 16 is rounded. The thickness of the insulation plate of the embodiment 3 is 8 mm and the edge around the hole 16 is rounded at a radius of 8 mm. The insulation plate 15 may be made of any insulation material, such as epoxy resin, ethylene fluoride (tetra-fluoroethylene), or glass-epoxy compound, so far as it is strong enough to withstand an external force to be generated in bending the coils.

With the above construction, coils can be bent always at the minimum radius of curvature, because of which the forming efficiency and bending accuracy of the coils improve and the length of the coil end in the axial direction of the rotary electric machine can be shortened. In addition, since the coils no longer contact any sharp edge around the slot in bending process, damage to the insulation coating on the coils can be prevented. If the distance between the coil at the coil end and the stator core is too close, leak current increases and so the generator efficiency decreases. By using an insulation plate 15, however, because a certain distance can be maintained between the coil 13 at the coil end and the stator core 5, the leak current can be minimized and the efficiency can be improved.

(Effects of the Invention)

With the present invention, as explained above, the stator can be smaller in size and a compact, high-efficiency and high-output rotary machine can be realized.

What is claimed is:

1. A stator, comprising a stator core equipped with multiple slots and coils built in the slots of the stator core;
multiple coils being laid in each slot and bent inward and outward in the radial direction of the stator.

2. A stator according to claim 1, wherein the coils bent inward in the radial direction of the stator are made equal in number to those bent outward.

3. A stator according to claim 2, wherein the coils bent inward and outward in the radial direction of the stator are three-phase concentric coil.

4. A stator according to claim 3, wherein the coils bent inward and outward in the radial direction of the stator are built into a layer structure of two rows by three layers.

5. A stator according to claim 1, wherein an insulation plate, which is provided with a hole corresponding to the slot, is put on the end of the stator core.

6. A stator according to claim 5, wherein the edge of the hole is rounded.

7. A stator according to claim 1, wherein the multiple coils laid in each slot are wound through other similar slots.

8. A rotary electric machine, comprising a housing, bearings fixed in the housing, a rotary shaft supported by the bearings, a rotor fixed on the rotary shaft, and a stator so fixed in the housing as to be positioned around the rotor;
the stator comprising a stator core equipped with multiple slots and coils built in the slots of the stator core; multiple coils being laid in each slot and bent inward and outward in the radial direction of the stator.

9. A rotary electric machine according to claim 8, wherein the coils bent inward in the radial direction of the stator are made equal in number to those bent outward.

10. A rotary electric machine according to claim 9, wherein the coils bent inward and outward in the radial direction of the stator are three-phase concentric coil.

11. A rotary electric machine according to claim 10, wherein the coils bent inward and outward in the radial direction of the stator are built into a layer structure of two rows by three layers.

12. A rotary electric machine according to claim 8, wherein an insulation plate, which is provided with a hole corresponding to the slot, is put on the end of the stator core.

13. A rotary electric machine according to claim 12, wherein the edge of the hole is rounded.

14. A rotary electric machine according to claim 8, wherein a permanent magnet is embedded in the rotor and fastened with a magnet cover.

15. A stator, comprising a stator core equipped with multiple slots and coils built in the slots of the stator core; multiple coils being laid in each slot and bent inward and outward in the radial direction of the stator; and the multiple coils laid in each slot being wound through other similar slots.
